(19) United States
(12) Patent Application Publication
(10) Pub. No.: US 2013/0227591 A1
(43) Pub. Date: Aug. 29, 2013

(54) ELECTRONIC DEVICE CAPABLE OF ADAPTING TO DIFFERENT TYPES OF PERIPHERAL DEVICES AND METHOD THEREOF

(71) Applicants: Hong Fu Jin Precision Industry (ShenZhen) Co.,Lt, (US); Hon Hai Precision Industry Co., Ltd., (US)

(72) Inventors: HUI-ZHANG WANG, Shenzhen (CN); GUI-MIN ZHU, Shenzhen (CN); HE-YOU YUAN, Shenzhen (CN); YA-FANG DING, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/707,958

(22) Filed: Dec. 7, 2012

(30) Foreign Application Priority Data
Feb. 29, 2012 (CN) 201210049830.4

(51) Int. Cl. G06F 13/10

(52) U.S. Cl. CPC G06F 13/102
USPC 719/321

(57) ABSTRACT

An electronic device capable of adapting different types of peripheral devices which providing a same function, includes a storage device storing a plurality of device drivers corresponding to a plurality of different type peripheral devices which provide a same function and a detecting module configured to identify one of the different type of peripheral devices connected to the electronic device, when the detecting module identifies a peripheral device connected to the device, the processor calls the device driver corresponding to the identified peripheral device from the storage device.

### BACKGROUND

1. Technical Field

Embodiments of the present disclosure relate to electronic devices with

ARM processors, and particularly, to a portable electronic device with an ARM processor that is able to adapt to different types of peripheral devices and method thereof.

2. Description of related art

Now smart phones and tablet computers are very popular, and a great number of the smart phones and tablet computers use ARM processors. Personal computers based on X86 framework can detect peripheral devices when they are connected to the mainboard and install device drivers for the devices. However, portable devices using ARM processors are set up to support only one peripheral device of each type such as a single type of 3G data card, however with so many aftermarket products available, and more being released all the time, a user may not want to be limited to only the few devices whose drivers are pre-installed in the portable device. It is useful and desirable to provide an electronic device with an ARM processor that can overcome such shortcoming.

### BRIEF DESCRIPTION OF THE DRAWINGS

FIG. 1 is a functional block diagram of one embodiment of an electronic device.

FIG. 2 is a flowchart of one embodiment of a method implemented by the electronic device of FIG. 1.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

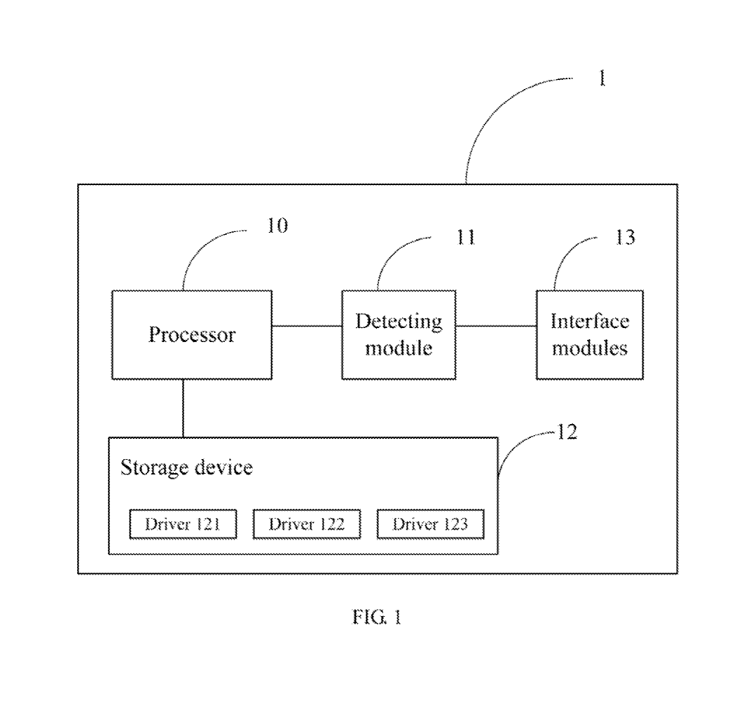

FIG. 1 is a block diagram of one embodiment of a portable electronic device 1, such as a tablet computer or a smart phone. The portable electronic device 1 includes an ARM processor 10, a detecting module 11, a storage device 12, and several interface modules 13 (e.g., a USB receptacle and a headphone jack). The storage device 12 and the detecting module 11 are electrically connected to the processor 10. Device drivers for different type of peripheral devices providing a same function, such as different types of 3G data cards, are stored in the storage device 12. The detecting module 11 is used for detecting whether a peripheral device is connected to the interface module 13 and identifying the type information of the peripheral device connected to the interface module 13 and sending the type information to the processor 10. The processor 10 is used for calling the device driver corresponding to the identified peripheral device based on the type information from the storage device 12.

In the embodiment, three different device drivers 121, 122, and 123 for three different type of peripheral devices providing a same function are stored in the storage device 12. When one of the three different type of peripheral devices providing a same function is connected to one interface module 13, the detecting module 11 identifies the type information of the peripheral device connected to the interface module 13 through a corresponding pin.

Specifically, different devices have different internal resistance values, and the detecting module 11 can determine whether a peripheral device is connected to one of the interface modules 13 and identify the type information the peripheral device by detecting the change of the resistance, voltage, or current of that interface module 13.

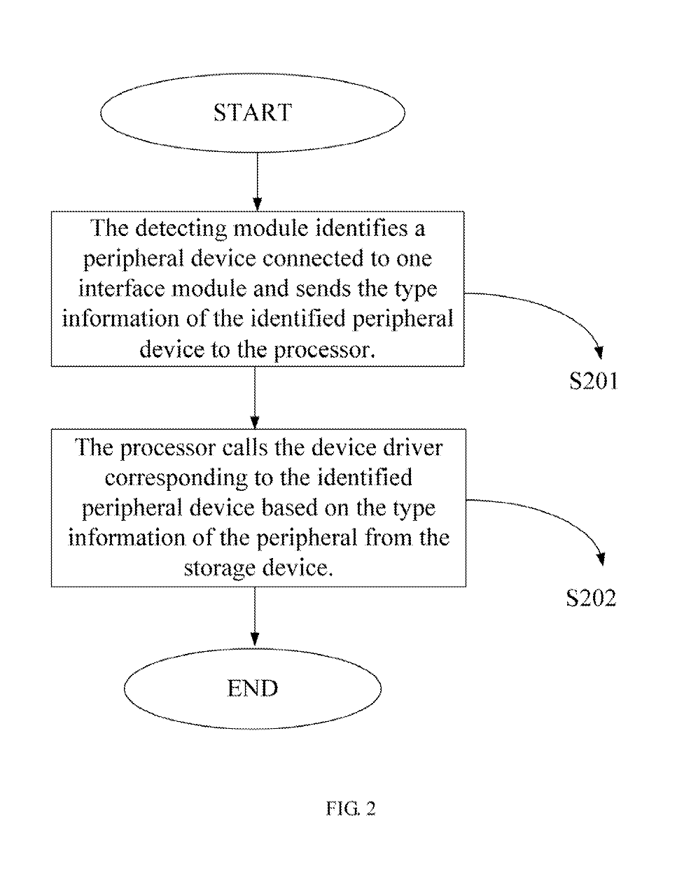

FIG. 2 is a flowchart of one embodiment of a method implemented by the electronic device 1.

In step S201, the detecting module 11 identifies a peripheral device connected to one interface module 13 and sends the type information of the identified peripheral device to the processor 10.

In step S202, the processor 10 calls the device driver corresponding to the identified peripheral device based on the type information of the peripheral from the storage device 12.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device comprising:
a storage device storing a plurality of device drivers, each of which corresponds to one of a plurality of different type of peripheral devices which provide a same function;
an interface module for connecting with one of the plurality of different type of peripheral devices which provide a same function;
a detecting module configured to identify the one connected to the interface module of the plurality of different type of peripheral devices which provide a same function; and
an ARM processor configured to call the device driver corresponding to the identified peripheral device connected to the interface module from the storage device.

2. The electronic device as described in claim 1, wherein the electronic device is a tablet computer or a smart phone.

3. A method implemented by the electronic device described in claim 1, the method comprising:
identifying the type information of the one of a plurality of different type of peripheral devices providing a same function connected to the interface module and sending the type information to the processor; and
calling the device driver corresponding to the identified peripheral device from the storage device.

4. The method according to claim 3, wherein the identifying type information of the one of a plurality of different type of peripheral devices which provide a same function connected to the interface module is conducted by detecting a change at the interface module in resistance, voltage, or current.
